(19) United States
(12) Patent Application Publication
(10) Pub. No.: US 2013/0133528 A1
(43) Pub. Date: May 30, 2013

(54) Locking Roasting Rack

(71) Applicant: Meyer Intellectual Properties Limited, Hong Kong (CN)

(72) Inventors: Homer CHEUNG, Hong Kong (CN); Mitchell Loring, San Rafael, CA (US)

(73) Assignee: MEYER INTELLECTUAL PROPERTIES LIMITED, Hong Kong (CN)

(21) Appl. No.: 13/681,038

(22) Filed: Nov. 19, 2012

Related U.S. Application Data
(60) Provisional application No. 61/564,101, filed on Nov. 28, 2011.

(51) Int. Cl. A47J 43/18

(52) U.S. Cl. CPC A47J 43/18
USPC 99/449

(57) ABSTRACT

A roasting rack is separable into two halves by a joining pin, the pin can be inserted into both halves in one orientation, but locked to preclude removal in another orientation by rotating the handle at the end thereof.

### CROSS REFERENCE TO RELATED APPLICATIONS

The present application claims the benefit of priority to the US Provisional Patent application of the same title that was filed on Nov. 28, 2011, having application Ser. No. 61/564,101, which is incorporated herein by reference.

### BACKGROUND OF INVENTION

The present invention relates to a cookware article, and in particular racks intended to support large foodstuffs during oven cooking and handle them after cooking

Prior cooking racks are capable of adjustment and reorientation, as well as being separated into to halves for easy removal sideways after the cooked foodstuff is placed on a counter, carving board or serving plate. This avoids the cook or user from having to lift the foodstuff off the rack after cooking

It is therefore a first object of the present invention to provide an improvement over the prior art, and in particular to provide a means that easily secures such a separable rack assembly, without adversely effecting size, complexity and cost, with a simple modification to avoid increase difficulty in cleaning and maintaining the same in a hygienic condition.

### SUMMARY OF INVENTION

In the present invention, the first object is achieved by a roasting rack kit comprising a first frame and a second frame, each substantially the mirror image of the other, and having a lower surface with a plurality of rings, and a pin formed substantially from an elongated shaft having a handle at one end and a protrusion from the shaft, wherein at least one of the rings is configured to allows the pin and protrusion to pass there though in one orientation of the handle, and to prevent such passage in a different orientation of the handle.

Other aspect of the invention include different features of the rack, as well as alternative shapes and location of the protrusion, that can be fixed and non fixed.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a first perspective view of an embodiment of the Roasting Rack in a closed assembled state,

FIG. 2 is a second perspective view of the embodiment of FIG. 1, in an open and separated state;

FIG. 3 is an expanded view of the handle portion in FIG. 1 showing the orientation thereof in the closed assembled state;

FIG. 4 is an expanded view of the handle portion in FIG. 1 showing the orientation thereof after rotation by 90 degrees from that shown in FIG. 3 and prior to removal and separation to form the view shown in FIG. 2;

FIG. 5 is the same view as in FIG. 4, but with ring member 135 removed to better illustrate the orientation of the stub 113.

FIG. 6 is the same view as in FIG. 3, but with ring member 135 removed to better illustrate the orientation of the stub 113;

FIG. 7 is a plan view of FIG. 4;

FIG. 8 is a plan view of FIG. 3,

FIG. 9 is a first perspective view of an embodiment of the Roasting Rack in a closed assembled state,

FIG. 10 is a second perspective view of the embodiment of FIG. 1, in an open and separated state;

FIG. 11 is a top plan view of the handle and stub portions of pin 111 in FIG. 9 showing the orientation thereof after rotation by 90 degrees from that shown in FIG. 3 and prior to removal and separation to form the view shown in FIG. 10; and

FIG. 12 is a top plan view of the handle and stub portions of pin 111 in FIG. 9 showing the orientation thereof in the closed assembled state.

FIG. 13 is a perspective view of a portion of another embodiment of the Roasting Rack in a closed assembled state.

FIG. 14 is a perspective view of a portion of another embodiment of the Roasting Rack in a closed assembled state.

FIG. 15 is a plan view of the Roasting Rack in FIG. 14.

FIG. 16 is a plan view of an alternative embodiment of the pin.

### DETAILED DESCRIPTION

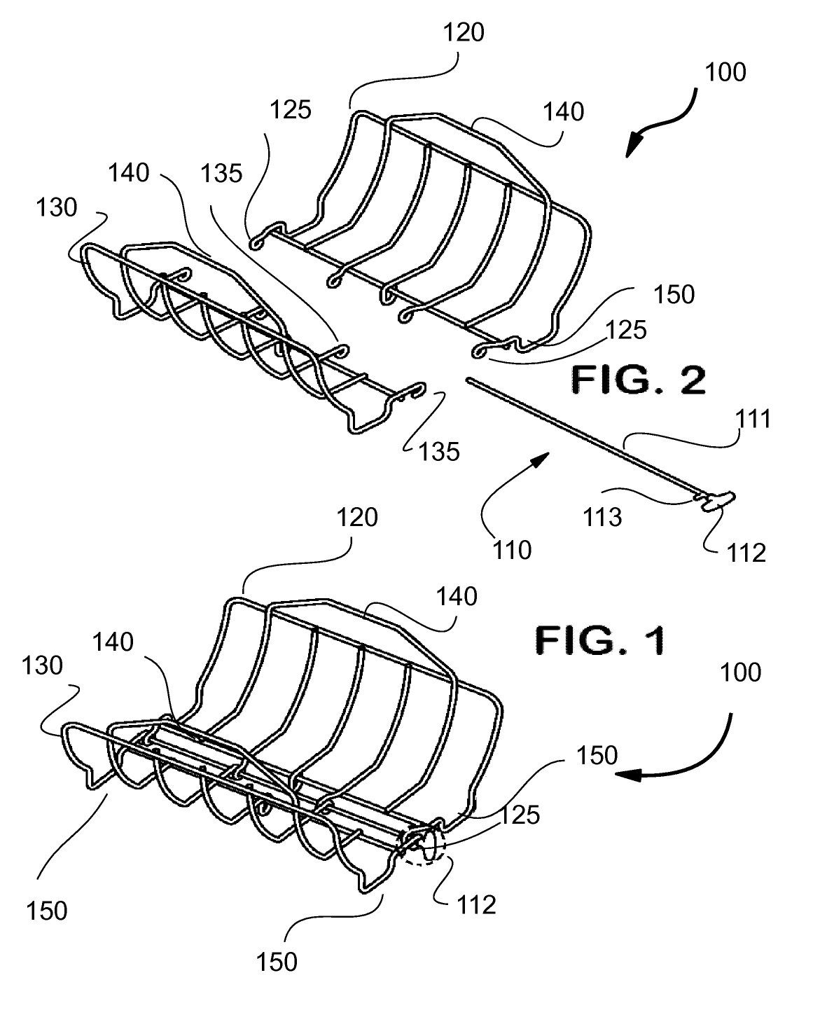

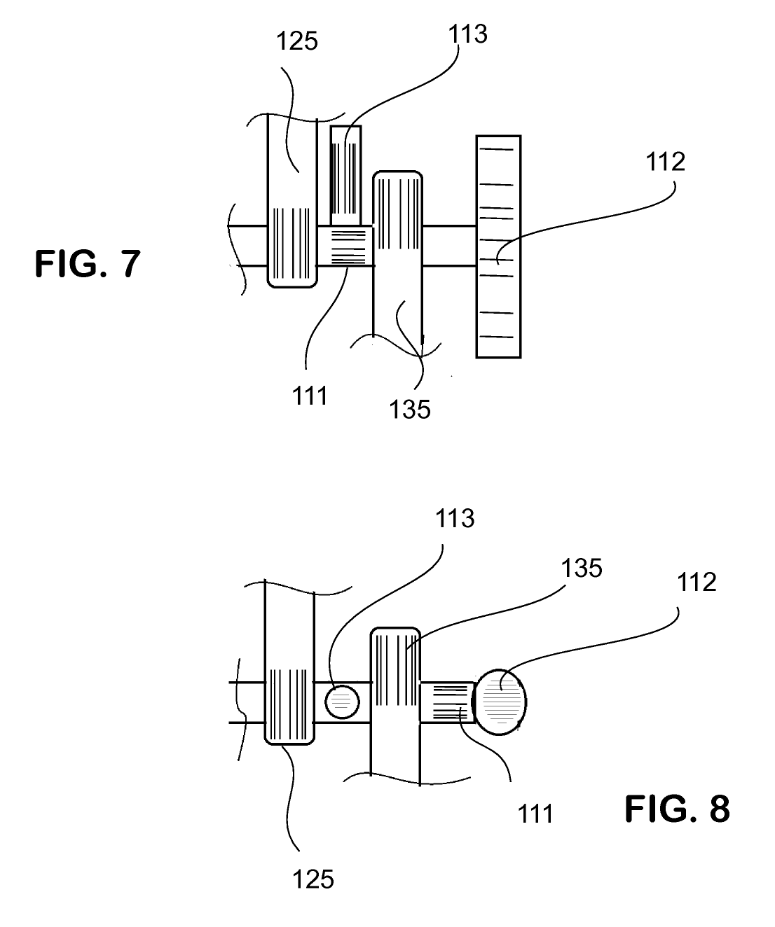

Referring to FIGS. 1 through 16, wherein like reference numerals refer to like components in the various views, there is illustrated therein a new and improved Locking Roasting Rack, generally denominated 100 herein.

In accordance with the present invention, a cookware rack has 2 separate frame components joined at the bottom, but separable so that the cooked item can be lifted by the handles, placed on a serving tray or cutting board and the rack removed without having to lift the hot foodstuff.

As disclosed in U.S. Pat. No. 6,164,194 (Issued on Dec. 26, 2000 to Westmoreland, O.) a roasting rack has 2 separate frame components in the form of grate like support member that are joined by various hinge means along a common axis. The hinge members are formed essentially by a pin that extends along the common side of the support members being insert into mutually adjacent holes along the common edge. For one member the holes are formed by looping the ends of wire that form the grate, while for the other member, the end of the wires that form the grate are inserted into a discrete hinge member having a single hole. The hinge member and the looped wire at the front and back ends of the grates are connected in rotary engagement by the pin that mutually extends between them.

In the present invention the means to join the separate frames or grate structure is pin that is inserted through a plurality of rings formed on the lower sections of two separate frame components, thereby joining the halves together, to form rack 100. An improvement consists of a means to lock the two separate frames 120 and 130 together, so the pin 110 cannot slide out accidentally, yet still providing facile removal of the pin 100 when it is desired to split the rack 100 into two halves to deposit the cooked foodstuff, such an entire chicken or turkey directly on a serving plate or cutting board. The frame components are grate or cage like, being formed of stiff wire members and are essentially mirror image of each other.

In this improvement, the pin 110 terminates with a handle 112 at the proximal end. The pin 110 has an elongated shaft 111 defined by a first cylindrical axis, and a protrusion, such as a short stub or cylinder 113 that extends perpendicular from the pin's first cylindrical axis. The protrusion or stub 113 can be proximal or distal from the handle, and is preferably radially co-oriented with a primary axis of an asymmetric handle 112 as discussed further below. However, handle 112 can have other shapes, including circularly symmetric, but in such case would preferably include an indicator of the orientation of stub 113.

Each mirror image half of the frame or grate terminates at the side intended to receive the pin with hinge forming member. It is preferable that the hinge forming members are fabricated by bending the ends of the wire segments that form the grate into at least partial loops. These wire segments are disposed orthogonal to the first cylindrical axis of the pin. Further, the hinge forming members have a hole that rather than being circular, is preferably oblong or non-circular to admit the stub in one orientation, but not in a second orientation that is achieved by rotating the pin about its first cylindrical axis. While it is preferable that the mutual holes in the hinge forming members on opposing mirror image frames are rectangular or oblong to accept a straight stub, the stub can have any arbitrary non circular shape that is matched in the hinge member so the stub has a key like fit in at least one hinge.

In a preferred embodiment the hinge members are formed by closely interlaced non-circular loop formed of the frame or grate forming wires, to provide at least one pair of receiving rings 125 and 135 that are oval or rectangular, having an opening in one radial direction with respect to the first cylindrical axis of the pin that is larger than the stub length, and an opening in another radial direction (preferably 90 degrees rotation from the first direction) that is shorter than the stub length. It should be understood that by stub length, we mean the largest radial dimension of the protrusion from the shaft 111 axis. However, as the pin formed a common axis to the hinge, the spacing between hinge forming members on opposing sides of the frame need not be immediately adjacent, but of sufficient spacing or number to provide reasonable rigidity to the assembled rack 100.

When the handle 112 is rotated to a first position the pin 110 can be inserted through all the laterally adjacent rings 125 and 135 on both frame halves, and through at least the first adjacent rings 135 on frame half 130.

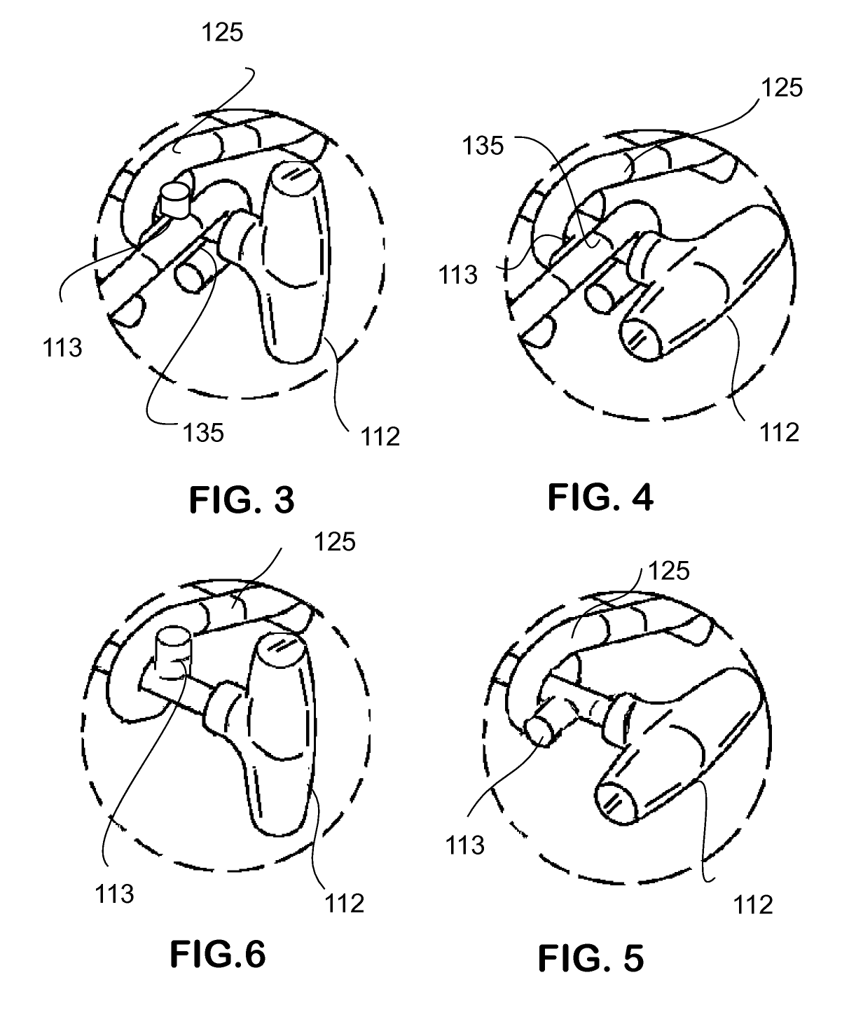

After such insertion, a rotation of the handle 90 degrees (FIGS. 3, 6 and 8) aligns the stub 113 with the short opening axis in the ring 135, so it cannot be pulled out. Accordingly, to fully insert pin 110 to reach this lockable position, the handle 112 is rotated so that the stub aligns with the wide opening axis in ring 135.

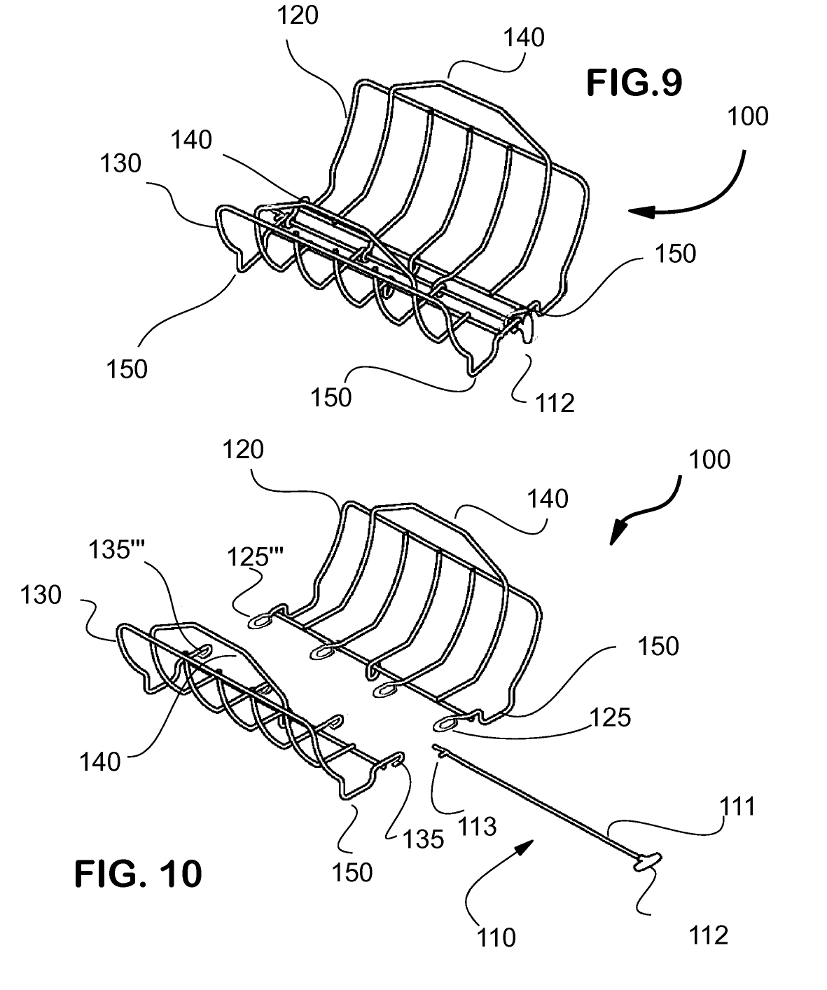

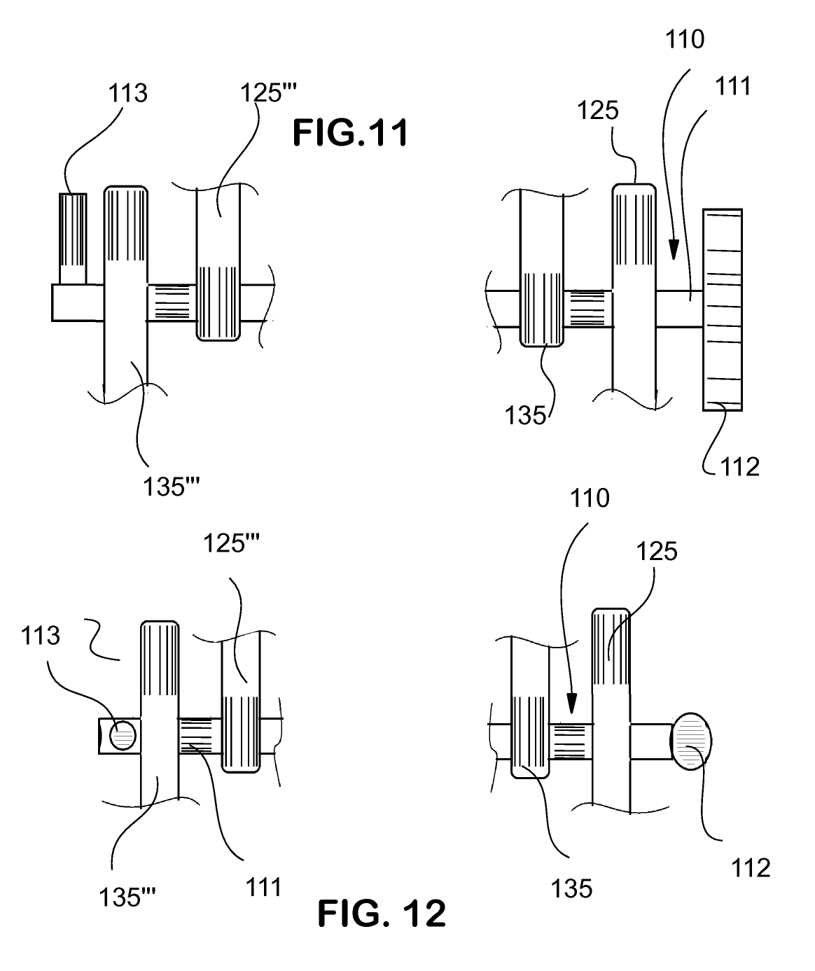

Alternative embodiments (FIG. 9-12) dispose the stub 113 distal from the handle 112, that is at the end of the pin 110. In this case the stub 113 must pass through all rings or loops 125 and 135 before the pin 110 is fully inserted, after which the handle 112 rotated to the locking orientation. In such an embodiment it is generally preferably that the rings on both frame halves are oval or rectangular. In the closed positions (FIGS. 11 and 12), the stub 113 advances past the last of both sets of rings, 125′″ and 135′″ upon full insertion of pin 110.

In a more preferred embodiment (FIG. 1-8), the stub is adjacent to the handle, being separated therefrom by a distance at least slightly greater than the width of the first ring 135. The pin can be inserted through all the rings but the first at any rotation of the handle. However, to lock the pin, the pin is rotated to that the stub can be insertion through only the ring most proximal to the handle, after which the pin is again rotated by the handle to the locking position, in which it is disposed between adjacent rings 125 and 135 of the two frame halves. Hence, on the first loop or ring 135 need have an oval or similar shape, to accommodate the advance of stub 113, while the remainder can be circular with an inner diameter greater than the outer diameter of the pin.

In other embodiments the handle, stub and rings can have different shapes yet still function as described above, such as with oval or rectangular rings.

Further one or more stubs 113 can be disposed anywhere on shaft 111 so long as in the final position the pin can be rotated within hindrance of the stub contacting one or more rings. However, it is preferred that the pin snugly fit into the rings or other hinge forming members to prevent lateral movement until rotated to the alternative position used for insertion.

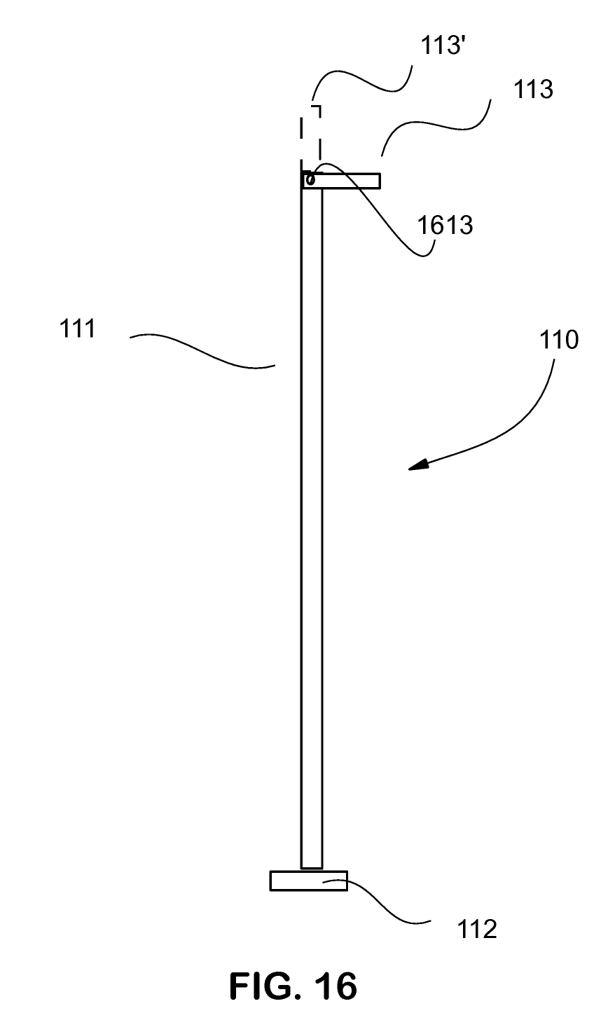

As illustrated schematically in FIG. 16, the stub 113 need not be fixed to permanently extending perpendicular to the shaft 111, but can be rotatable from a co-linear position (113′) at the end of the shaft 111. Hence. the rings can have a narrower and constant inner diameter, as in circular rings, provided the combined thickness of the shaft 111 and stub 113 when co-linearly positioned is less than the inner ring diameter. Accordingly, such a re-positionable stub 113 can be at the end of the shaft distal form handle 112, being connected by a joint 1613, or disposed within a side cavity in shaft 111, or handle 112 if configured to slide out from the handle along shaft 111 before being disposed in the locking position.

Further, in the preferred embodiments each frame half 120 and 130 has a handle 140 so the combined rack 100 can be lifted by the pair of handle or separated by the handles when the pin is removed. Further, the rack 110 optionally has feet 150 or other means to hold the ring assembly and pin off the cooking or food preparation surface. The feet 150 are preferred formed by bending pairs of wire from each side of each frame halve to form a segment that sits below the plane defined by the other wires not so bent. Alternatively, feet 150 can be formed by adding material to the frame that extends below this frame. Thus, each frame half 120 and 130 would have a pair of feet 150, each disposed at the front and back sides that are respectively adjacent the handle or proximal position on pin 110 and the distal portion thereof

It is also preferred that the rack halves 120 and 130 are not flat by are at least slightly curved inward toward the mating half so the rack 100 coupled by the pin 110 has a cage like at least partially cylindrical shape, as shown in FIG. 1 sand 9. Hence, the rack 100 can also be configured to form a cage by overlapping at handles 140, when the halves are rotated upward toward each other at the joint formed by the pin inserted into the lower rings, which are optionally locked by additional rings and a pin a the top proximal to the handle.

The frames 120 and 130 while preferably formed of stiff wire members that connect at crossings to form a grate or cage like structure, can also be formed by removing material from solid sheets, leaving sufficient holes for radiant heating as well as mass heat transfer to the food stuff contained thereon. The stiff wires that form the grate can have any cross-sectional shape.

Further, while it is preferable that the frame members 120 and 130 can rotate toward and away from each other via the hinge members, to accommodate and support different size and shape foodstuff, the hinged connection is primary to enable locked engagement and disengagement of the pin by rotation about its primary axis. Thus, the frame halves 120 and 130 can be connected in a manner that precludes mutual rotation, but requires the rotation and removal of the pin 110 to effect their separation.

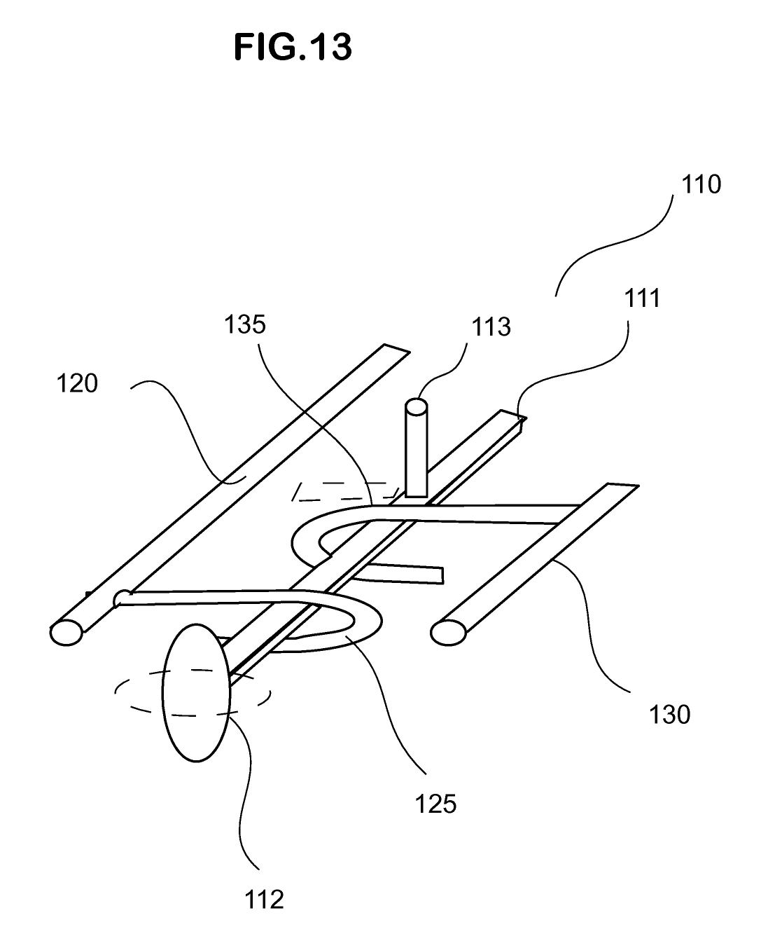

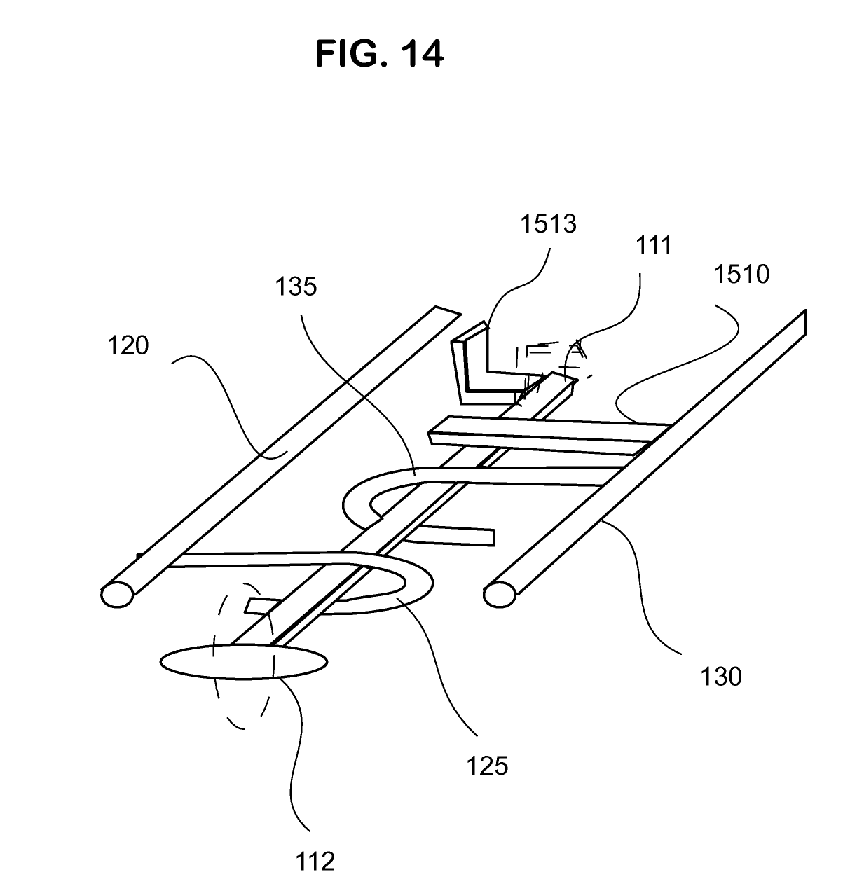

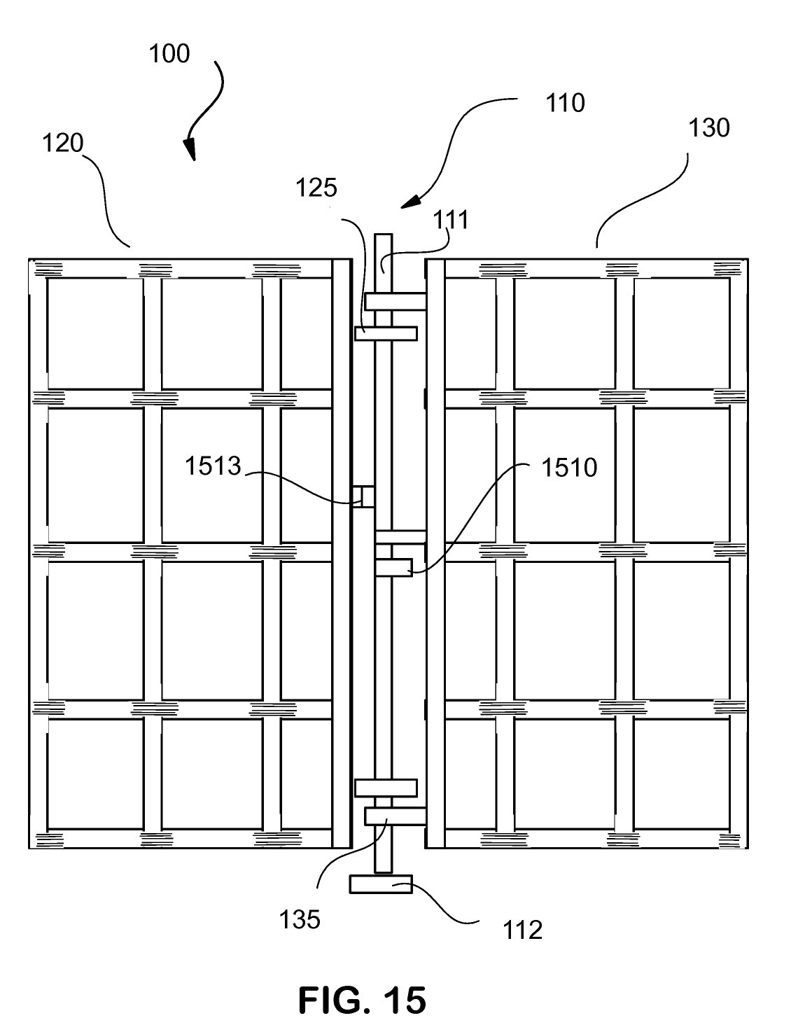

Further, additional structure external to the hinge members, such as arm 1510 in FIGS. 14 and 15, be used to lock or grasp an extending member or stub 1513, Depending on the shape of the extending member or stub 1513 and arm 1510 a combination of multiple rotations as the pin 110 is advanced or withdrawn from the hinged connection of the frame halves may be required. As or example, the engaging member may be a single non-round loop formed from only a portion of one frame, or 2 partial loop formed by adjacent portions form the adjacent frame halves. In FIGS. 13 and 14 the hinge members are formed from a pair of partially looped wires 125 and 135 that together provide a closed oval shape that admits stub 113 in one orientation, but not another.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A hinged roasting rack comprising
a) a first frame and a second frame, each substantially the mirror image of the other, and having at a mutually adjacent side a plurality of interconnectable hinge members,
b) a pin formed substantially from an elongated shaft and having a handle at one end and a protrusion from the shaft, the protrusion extending orthogonal to a primary axis of the pin, in which the pin is inserted through the hinge members to engage the first and second frames,
c) wherein at least one of the interconnectable hinge members is configured to allows the pin and protrusion to pass there though in a first orientation of the handle, and to prevent such passage in a second orientation of the handle that is rotated about the primary axis of the pin.

2. The hinged roasting rack according to claim 1, wherein the protrusion is disposed adjacent to the handle.

3. The hinged roasting rack according to claim 1, wherein the protrusion is disposed at an end of the pin distal from the handle.

4. The hinged roasting rack according to claim 1, wherein the hinge members are formed from at least partly looped wires that form the frame structure.

5. The hinged roasting rack according to claim 1, and further comprising a handles at a side of each frame that is opposite the mutually adjacent side having the plurality of adjustable hinge members.

6. The hinged roasting rack according to claim 4, wherein one or more of the partly looped wires that forms a hinge member has an oblong shape.

7. The hinged roasting rack according to claim 6 wherein the one or more of the partly looped wires that forms a hinge member has an oblong shape is disposed immediately adjacent an edge of at least one mutually adjacent side of the first or second frame.

8. The hinged roasting rack according to claim 7, wherein the protrusion is disposed adjacent to the handle and need only pass through the oblong looped wire that is disposed immediately adjacent the edge of at least one mutually adjacent side of the first or second frame to prevent withdrawal of the fully inserted pin after it is rotated by the handle to the second orientation.

9. An roasting rack comprising:
a) a first frame and a second frame, each substantially the mirror image of the other, and having at mutually adjacent sides a plurality of hinge member capable of mutual engagement, and
b) pin formed substantially from an elongated shaft having a handle at one end and a locking means disposed on the shaft,
c) wherein at least one of the first frame, second frame and hinge members is configured to engage the locking means after the pin is inserted to mutually engage the hinge members,
d) wherein the locking means is operative to preclude removal of the pin from engagement with the hinge members until it is rotated about a primary axis thereof.

10. The roasting rack according to claim 9, and further comprising a handles at a side of each frame that is opposite the mutually adjacent side having the plurality of hinge members capable of mutual engagement.

11. The roasting rack according to claim 9, and further comprising two or more feet descending downward from each of the first and second frame for positioning the frames above a supporting surface.

12. The roasting rack according to claim 10, wherein the two or more feet descending downward from each of the first and second frames are formed of wires that form two sides of each of the first and second frame that are immediately adjacent to the mutually adjacent sides thereof.

13. The roasting rack according to claim 9, wherein the locking means is a deviation from a round cross-section profile orthogonal to a primary axis of the pin on other portions of the pin.

14. The roasting rack according to claim 13, wherein the deviation is a cylindrical peg extending orthogonal from the primary axis of the pin.

15. An roasting rack kit comprising:
a) a first frame and a second frame, each substantially the mirror image of the other, and having a mutually adjacent sides with a plurality of rings, wherein the rings associated with each frame are disposed to interlace with those of the other frame upon the alignment of the mutually adjacent sides,
b) a pin formed substantially from an elongated shaft having a handle at one end and that is configured for insertion into the plurality of interlaced rings from the first and second frame to provide a hinged attachment members there between, the pin also comprising a locking means,
c) wherein at least one of the first frame, second frame and hinge members is configured to engage the locking means after the pin is inserted to mutually engage the hinge members,

16. The An roasting rack kit according to claim 15 wherein the locking means is operative to preclude removal of the pin from engagement with the hinge attachment members until it is rotated about a primary axis thereof

17. The roasting rack kit according to claim 15, wherein each of the first and second frame further comprises a handles at a side of each frame that is opposite the mutually adjacent side having the plurality of rings disposed to interlace with those of the other frame.

18. The roasting rack according to claim 15, wherein each of the first and second frame further comprises two or more feet descending downward for positioning the frames above a supporting surface.

19. The roasting rack according to claim 18, wherein the two or more feet descending downward from each of the first and second frames are formed of wires that provide two sides of each of the first and second frame that are immediately adjacent to the mutually adjacent sides thereof.

20. The roasting rack kit according to claim 15, wherein the locking means is a protrusion from the pin that is disposed adjacent to the handle and the protrusion need only pass through an oblong ring of looped wire that is disposed immediately adjacent the edge of at least one mutually adjacent side of the first or second frame to prevent withdrawal of the pin after being fully inserted through the plurality of rings.
